(19) United States
(12) Patent Application Publication
(10) Pub. No.: US 2010/0211884 A1
(43) Pub. Date: Aug. 19, 2010

(54) SYSTEM AND METHOD FOR JOINT USER PROFILE RELATING TO CONSUMER ELECTRONICS

(75) Inventors: Praveen Kashyap, Irvine, CA (US); Dang Van Tran, Laguna Niguel, CA (US); Toshiro Ozawa, San Diego, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/371,444

(22) Filed: Feb. 13, 2009

(51) Int. Cl. G06F 3/00

(52) U.S. Cl. 715/745

(57) ABSTRACT

Embodiments include a system and method of a user login to a multimedia system such that a joint user profile is used for controlling multimedia content when two or more users are logged into the multimedia system. For example, in one embodiment a method of controlling multimedia presented by a multimedia system includes logging in two of more user profiles to a multimedia system. The method also includes determining a joint user profile based at least in part on the two or more logged in user profiles, and then applying the joint user profile to control at least some multimedia content output by the multimedia system.

### RELATED APPLICATION

This application is related to U.S. patent application Attorney Docket No. SAMINF.183A, titled “SYSTEM AND METHOD FOR USER LOGIN TO A MULTIMEDIA SYSTEM USING A REMOTE CONTROL,” filed on even date herewith, and which is incorporated herein by reference in its entirety.

### BACKGROUND OF THE INVENTION

1. Field of the Invention

This application relates to control and interaction with televisions and other media playback devices.

2. Description of the Related Technology

Identifying a particular viewer (or user) of a computer or multimedia playback device (collectively referred to as “multimedia systems”) can be useful for controlling information presented to the user and personalizing the user's multimedia experience. To identify a particular user to a multimedia system the user may be required to perform an identification process. For example, navigating through a series of menus, or entering a password comprising a plurality of alphanumeric characters. After a user logs in, default or previously selected characteristics associated with the user can affect the presentation of image and audio data to the user. For example, a user of a computer can select preferred characteristics, such as a display background image, a screen saver, or which application and shortcut icons are presented on a display, and the characteristics are displayed whenever that user logs in. However, current login control systems use characteristics associated with a single logged in user which may not be suitable for environments when multiple users located at the same place are viewing multimedia content. Accordingly, a need exists for improved login methods and devices that are designed to be used when multiple users are viewing multimedia content.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed. After considering this discussion, and particularly after reading the section entitled “Detailed Description of Certain Embodiments” one will understand how the features of this invention provide advantages that include controlling multimedia content presented to two or more viewers who are viewing multimedia content together based on a joint user profile, the multimedia content provided on a television, a display or other media playback devices.

One embodiment includes a method of determining a joint user profile to control multimedia content presented by a multimedia system for personalizing a multimedia experience for two or more users, the method including logging in a first user profile on the multimedia system, logging in a second user profile on the multimedia system while the first user profile is logged in, determining a joint user profile based at least in part on the first user profile and the second user profile, and applying the joint user profile to control at least some multimedia content output by the multimedia system. The method may further comprise presenting multimedia content on the multimedia system, which may be a television, computer system, or any other audio-visual media presentation system. The method may further comprise associating one or more characteristics affecting presentation of multimedia content with the first user profile, and associating one or more characteristics affecting presentation of multimedia content with the second user profile, where the joint user profile comprises characteristics determined at least in part by at least one characteristic associated with the first user profile or the second user profile. The one or more characteristics may relate to one or more of favorite channels, favorite genre, personal bookmarks, rating limits, instant messenger identities, picture configurations, sound configurations, preset search keywords, screen design, and viewing history. The characteristics associated with the joint user profile can include a set of characteristics defined by the intersection, or union, of characteristics associated with the first user profile and characteristics associated with the second user profile.

The method of determining a joint user profile to control multimedia content presented by a multimedia system for personalizing a multimedia experience for two or more users can further comprise associating a first signal with the first user profile, associating a second signal with the second user profile, and receiving the first and second signal in the multimedia system, where the multimedia system logs in the first user profile based on receiving the first signal, and logs in the second user profile based on receiving the second signal. In some embodiments the method can include communicating the first signal and the second signal from a remote control device to the multimedia system. In some embodiments the method can include logging in at least one additional user profile, and re-determining a joint user profile to apply to control at least some of the multimedia content presented by the multimedia system, the joint user profile based at least in part on the first user profile, the second user profile, and the at least one additional user profile. The method also may re-determine the joint user profile if a user profile is logged off and two or more user profiles remain logged in. And if users log out such that only one user profile is logged in, the method may apply a single logged in user profile to control at least some multimedia content output by the multimedia system. The method can include gathering content viewing information by monitoring multimedia content output by the multimedia system while the joint user profile is applied, and changing the joint user profile based on the monitored content. The content viewing information can include data relating to one of more of: which show was viewed, how long was a show viewed, when was a show viewed, and which channels were viewed.

Another embodiment includes a method of controlling multimedia content output by a multimedia system, the method comprising logging in two or more user profiles to a multimedia system, applying a joint user profile to control at least some multimedia content output by the multimedia system, the joint user profile based at least in part on the two or more logged in user profiles. The method can further comprise determining one or more joint user profiles, each based, for example, on a combinations of two or more user profiles that have been created on the system. The method can further comprise logging in a third user profile such that there are at least three logged in user profiles, and applying a joint user profile to control at least some multimedia content output by the multimedia system, the joint user profile based at least in part on the at least three logged in user profiles. The method can further comprise logging off one of the logged in user profiles, and re-determining a joint user profile to control at least some multimedia content output by the multimedia system, the re-determined joint user profile based at least in part on the two or more remaining logged in user profiles.

Another embodiment includes a multimedia system that can include a processor configured to log in two of more user profiles to a multimedia system, determine a joint user profile based at least in part on the two or more logged in user profiles, and apply the joint user profile to control multimedia content output by the multimedia system.

Another embodiment comprises a multimedia system comprising a processor configured to determine a joint user profile for controlling multimedia content presented on a display based at least in part on two or more logged in user profiles. The multimedia system can further comprise a television that includes a display. The multimedia system can further comprise an output system, which may comprise a display for outputting visual multimedia content. The processor can be further configured to apply the joint user profile to control multimedia content output by the output system. The multimedia system can further comprise a receiver in communication with the processor, the receiver configured to receive signals corresponding to user profiles for logging in to the multimedia system, where the processor is further configured to log in user profiles based on the signals received by the receiver. The system can further comprise an input device (e.g., a remote control device) configured to generate signals corresponding to user profiles and communicate the signals to the receiver. The multimedia system can further comprise a memory component configured to store at least one characteristic associated with each of the two or more logged in user profiles, and wherein the processor is configured to determine the joint user profile based at least in part on at least one characteristic associated with the first user profile or the second user profile.

Another embodiment includes a computer-program product for determining a joint user profile for personalizing a multimedia experience, the product comprising a computer-readable medium having stored thereon codes executable by at least one processor to log in two of more user profiles to a multimedia system, determine a joint user profile based at least in part on the two or more logged in user profiles, and apply the joint user profile to control at least some of the multimedia content output by the multimedia system.

In another embodiment, a system for determining a joint user profile for personalizing a multimedia experience includes means for logging in two of more user profiles to a multimedia system, means for determining a joint user profile based at least in part on the two or more logged in user profiles, and means for applying the joint user profile to control at least some of the multimedia content output by the multimedia system. The logging in means can comprise a remote control device. The determining means can comprise a processor in communication with the remote control device and configured to receive a signal from the remote control means indicative of a user profile for login. The applying means can also comprise a processor.

### BRIEF DESCRIPTION OF THE DRAWINGS

FIG. 1 is a block diagram illustrating components of one embodiment of a system for controlling usage of a television or other media access device.

FIG. 2 is a schematic illustrating components of one embodiment of a multimedia system for use in connection with the system of FIG. 1.

FIG. 3 front view of one embodiment of a control device such as used to control the device illustrated in FIG. 2

FIGS. 4A and 4B are tables illustrating examples of button sequences for identifying user profiles.

FIG. 5 is a schematic illustrating another embodiment for inputting a user selection indicating a user profile for login to a multimedia system.

FIG. 6 is a flowchart illustrating one embodiment of a method of logging in to a multimedia system.

FIG. 7 is a schematic illustrating an example representation of a data structure that can be used to store user profiles, including user profile characteristics and their attributes.

FIG. 8 is a example of a portion of a user interface that can be displayed on a display of a media access device and used for tailoring characteristics of a user profile for a particular user.

FIG. 9 depicts a state diagram illustrating one example of multi-user login and resulting joint user profiles.

FIG. 10 is a flowchart illustrating one embodiment of a method of determining a joint user profile to control multimedia content.

### DETAILED DESCRIPTION OF CERTAIN EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

As noted above, current login control systems may implement login processes that require a user to enter usernames and passwords to login to a personal computer or other multimedia system (e.g., a television). Such login processes are often tedious and unnecessarily complex, and do not address the particular needs of the system. Fast and simple logins are desired for a multimedia system in which one or more viewers may want to login and logout numerous times during the day as they move into and out of the proximity of the multimedia system. In addition, multiple users often view multimedia content (also referred to herein simply as “content”) on a multimedia system simultaneously. The user or group of users viewing the content may change often. Tailoring content to be desired and appropriate for a certain single user, or a certain group of users (or viewers), can make the multimedia experience more enjoyable. For example, a parent may want to block certain content from being presented to a child while the child is watching television alone, and self-regulate the presented content while watching television with the child.

One embodiment includes a method of logging in one or more users on a multimedia system that allows a user to login (or logout) by actuating a single button on an input device, or by actuating a short sequence of one or more buttons on the input device. In one embodiment, the input device is a remote control device having a plurality of buttons. In one embodiment, the multimedia system includes one or more televisions. As used herein, logging in a user relates to identifying a particular user profile on a multimedia system that the system can apply to provided multimedia content presented to the user. A user profile can include one or more characteristics, each having attributes that are either selected or entered by a user. The characteristics can be used by software and/or hardware in the multimedia system to control multimedia content output by the multimedia system while the user is logged in, thereby personalizing a user's multimedia experience. The system can store the user profile in a database or another suitable type of data structure. Some of the characteristics may describe a particular user, for example, indicating age or gender. Other characteristics may relate to a user's preferences for experiencing multimedia content, for example, setting initial or maximum sound levels, graphics, and picture settings.

The multimedia system can include an output system, a remote control device, a memory component configured to store one or more user profiles, and a multimedia processor configured to login one or more profiles bases on the signal received from the remote control device. In some embodiments, the multimedia system includes data-mining components that monitor usage of the system and gather information relating to viewed multimedia content. The gathered information can be used to change a user profile to more accurately reflect a user's preferences. The information can also be provided to content providers for analysis, e.g., marketing analysis. The output system can also include an image display device (for example, a display comprising plasma, LCD, LED, CRT, or OLED technology) and/or an audio component (for example, a speaker).

To identify a particular user profile to the multimedia system, one or more button actuation sequences on an input device can be associated with a user profile. When a signal is received indicating a particular button actuation sequence has been performed (indicating the particular user is present), the multimedia system applies the associated user profile. In some embodiments, a single button (for example, a red, green, blue or yellow button on the input device) can be associated with a particular user profile, and the user only has to actuate one button to select a user profile for login. In other embodiments, a sequence of buttons actuations (for example, red/blue, red/yellow, or blue/red) can be associated with a particular user profile, and the user actuates the desired sequence of buttons to login. A signal corresponding to a button actuation sequence is communicated from the input device to the multimedia system indicating a first user profile for login. The first user profile is logged into the multimedia system so that the multimedia system recognizes the logged in first user profile as an active user profile. Multimedia content provided to an output system of the multimedia system is then based on the active user profile. When a second user logs into the multimedia system, a joint user profile is applied as the active user profile.

The joint user profile is based on at least two user profiles. When multiple user accounts are created on the multimedia system, the multimedia system can create multiple joint profiles, for example, one joint profile for each possible combination of defined users. A joint profile for a specific combination of logged in two or more users can be created based on each user's defined settings, preferences or information, for example, the user's age, gender, “role” (e.g., parent or child), geographic location, or multimedia image or audio content preferences. In some embodiments, a joint profile is formed based on a union, intersection or priority of characteristics of the individual user profiles. For example, settings and preferences in each of the individual user profiles used to create the joint profile. Here, “union” refers to a combination of one or more characteristics from all of the user profiles, where “intersection” refers to a combination of the characteristics that are in each user profile. In addition, in some embodiments the multimedia system can employ data-mining to track the content viewed and/or settings used when a particular joint profile is applied to control multimedia content. Such tracked information can be used by content providers to gather data on viewers and groups of viewers. In some embodiments, the tracked data can be used to revise a joint profile to more accurately reflect the preferences users viewing the multimedia content together. In other words, the multimedia system can “learn” characteristics of a certain joint user profile based on monitoring the viewed content when the combination of users included in the joint user profile are logged in.

As used herein, the terms “viewer” and “user” (used synonymously herein) are broad terms that refer to a person who views and/or uses multimedia content, and includes one who accesses multimedia content including one who views audio-video content, views video-only content, plays or accesses audio-only content, interacts with or plays a video game or other interactive program, or views or accesses any other multimedia content. “Multimedia content” (also referred to herein as “content”) is a broad term and refers to audio, video, still images, or any other type of visual or audio information. For example, multimedia content may include television or other video broadcast content, video or audio on-demand or downloaded content, or content from the Internet or another network.

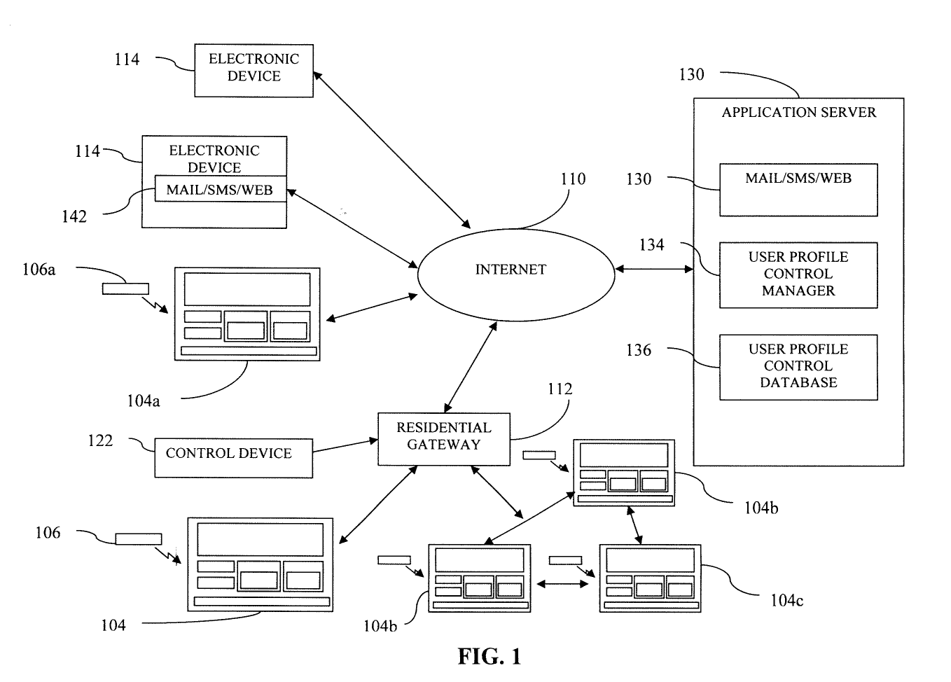

FIG. 1 is a block diagram illustrating components of one embodiment of a multimedia system 100 for providing multimedia content. Embodiments of system 100 are configured to quickly and easily log in one or more users, and control multimedia content provided to the logged in users based on the users profiles. In one embodiment, a user logs in to a media access device 104 by actuating a sequence of one or more buttons on an input device. The buttons used to facilitate a user login can be disposed directly on the media access device 104, or on a component of the media access device 104. In some embodiments a voice activation system is incorporated in the media access device 104 or another component of the system 100, and a user logs into the system using voice control commands (for example, a person's name). In some embodiments, the one or more buttons are disposed on a remote input device (e.g., a remote control device or “remote control”) 106 that is in communication with the media access device 104. The remote control 106 is configured to send a signal associated with an actuation sequence of one or more buttons to indicate which user is logging in.

Still referring to FIG. 1, the system 100 includes a user profile control manager 134 that can be configured to apply characteristics of one or more user profiles that are logged into the system to control multimedia content presented to the logged in viewer(s). The user profile control manager 134 can receive login information and apply a user profile, which can be a joint user profile if more than one user is logged in. In some embodiments, a first user logs into a media access device 104, thereby selecting a first user profile to be the “active” user profile. The user profile control manager 134 applies the active user profile to control multimedia content. Subsequently, a second user can log into the media access device 104 while the first user is still logged in. In such cases, the user profile control manager 134 can apply a joint user profile, that was formed based on one or more characteristics of the first and second user's profile, as the active user profile. The user profile control manager 134 applies the joint user profile to control multimedia content provided to the logged in users. Similarly, a third user can log into the media access device 104, and/or additional users can log in while one or more other users are previously logged in. The user profile control manager 134 can apply another joint user profile which was generated based on the plurality of logged in users, and uses this joint profile to control multimedia content provided to the group of logged in users. When a user logs out, and if more than one user is still logged in, the user profile control manager 134 can apply a joint profile related to the remaining logged in users as the active profile. If only one user remains logged in, the user profile control manager 134 can apply the remaining user's profile as the active profile.

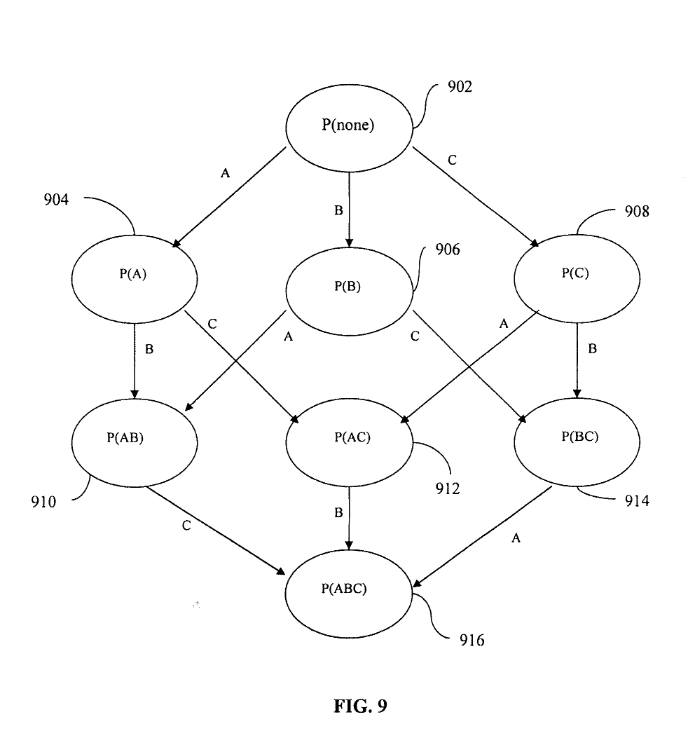

The joint user profile may be based on one or more characteristics of two or more user profiles. When multiple user accounts are created, multiple joint profiles can be created for each combination of two or more joint users so that the joint profile can be quickly applied upon the second (or additional) user logging in. The joint user profile for a certain group of two or more users can be based on the profile of each user in the group. For example, on information related to the user (e.g., age category, gender, role (parent or kid)), what each user has defined as a setting or preference (e.g., resolution, font size, color setting, audio level) in their profiles, and/or information the multimedia system can data-mine by monitoring viewed content (e.g., what channels are watched the most, how long a show is watched, genre preference). Forming and using joint profiles are described herein in further detail in connection with FIG. 9. In some embodiments, a joint profile can be created dynamically when a second (or additional) user logs into the system 104.

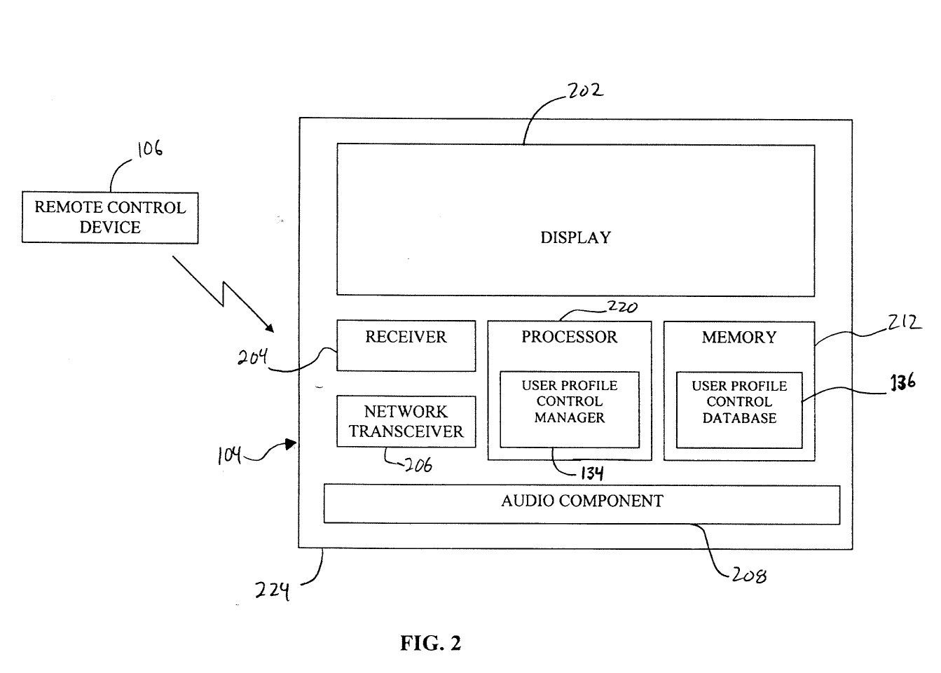

In some embodiments, the media access device 104 illustrated in FIG. 1 can be a standalone television that receives user login information and controls the output of multimedia content independently. In such cases, a storage medium for user profile information (e.g., a memory component storing a database or other data structure) and a processor configured to process logins and associated user profiles, and control multimedia content based on the user profiles, may be incorporated on the standalone television 104, as described in connection with FIG. 2. In some embodiments, although operating to control user logins and multimedia content independently, media access device 104 can be optionally connected to and in communication with additional components, for example, a residential gateway 112 and a network 110. As illustrated in FIG. 1, a plurality of media access devices 104b-d maybe in communication with each other and share information, for example, user login or profile information. In other words, each television 104 may provide login control and control multimedia content output based on an active single profile or a joint user profile independently. Alternatively, a number of televisions 104b-d may provide user login/profile control in coordinated fashion with other televisions 104. In some embodiments, an application server 130 can provide configuration and synchronization between several televisions 104, 104a-d.

A illustrated in FIG. 1, the media access device 104 may be in communication with other components of system 100, for example, via one or more routers such as a residential gateway 112, and/or an application server 130, via the Internet 110 or another local area network (“LAN”) or a wide area network (“WAN”). The residential network gateway 112 may comprise one or more of an IP router, a cable modem, a DSL modem. The application server 130 can be a separate electronic device that coordinates user login and profile control by the televisions 104 via a network 110. In such embodiments, the application server 130 can include a user profile control database 136 that contains the user profiles. The application server 130 can also include the user profile control manager 134 can be configured to perform one or more of login one or more users, control application of user profiles, determine an active user profile based on a single logged in user, determine a joint user profile to use as the active user profile if more than one user is logged in, and control multimedia content provided to an output of a media access device 104 based on the active user profile. In other embodiments, the application server 130 may be integrated with one or more of the media access devices 104. The application server 130 can be configured to communicate user profile information, including but not limited to the active user profile, to the applicable media access device 104 for a particular user or group of users.

In some embodiments, user login buttons are incorporated in another control device 122 that communicates a signal corresponding to the button actuation sequence of one or more users logging into a media access device 104 through another component of system 100, for example, the residential gateway 112. In such cases, the residential gateway 112 can communicate user login information to a standalone media access device 104 or a group of media access devices 104b-d.

In one embodiment, user profiles may be modified via a user interface provided by the media access device 104. In some embodiments, the application server 130 may provide a configuration user interface, via the television 104, or via another electronic device 114 that is networked with the application server 130. Such electronic devices may include personal computers, PDA's, portable/laptop computers, cell phones, or any other suitable electronic device. In one embodiment, the electronic device may include the application server 130. For example, in one embodiment, the electronic device 114 is a personal computer that also provides the application server 130.

While certain embodiments are described in connection with FIG. 1 with reference to an access device 104 comprising a television (e.g., a video monitor, an audio output component, and broadcast television receiver), in other embodiments, the media access device 104 may be embodied as a video monitor (e.g., without receivers), a cable or satellite set-top boxes, a digital video recorder (DVR), a video disc player (e.g., DVD or other format discs including high definition discs), a mobile telephone handset, or another multimedia access device. Moreover, a particular system 100 may include any number and type of such media access devices 104.

The application server 130 may be embodied as a server computer or distributed server computing system, as an electronic device such as a personal computer, or within a particular television 104. The application server 130 illustrated in FIG. 1 may include the user profile control manager 134 that provides and maintains usage user login and user profile information via a user profile control database 136. The application server 130 may communicate via the network 110 with one or more televisions 104 to provide user login/profile data. In one embodiment, the application server 130 communicates with the televisions 104 to request synchronization when the application server 130 receives and stores updated user login/profile data. In another embodiment, the televisions 104 request updated data in response to viewer requests for access to content. In one embodiment, the application server 130 does not include the user profile control database 136, but rather the user profile control manager 134 coordinates and maintains the access control data 134 of each television 104. In operation, the user profile control manager 134 can receive new or updated user profile data from media access devices 104 (based on a user's input), and update, or synchronize, a user profile control database 136 resident on one or more media access devices 104.

The application server 130 shown in FIG. 1 may include a user interface module 132 that provides an e-mail, short message system (SMS), or web (e.g., HTML via HTTP) interface for maintaining the access control database 136. The application server 130 may maintain user profile data based on a user login, which in one embodiment is tied to an email, text message, instant message or other identifier. This can be used to facilitate providing emails, text messages, instant messages, or other electronic communications to the logged in user(s) as specified in the user profiles.

The electronic device 114 illustrated in FIG. 1 may include a memory, processor, storage, a display, and one or more user input devices to provided a user interface configured to configure and maintain user login and profile data with the application server 130. In one embodiment, the electronic device 114 includes a web browser, e-mail client, SMS client, or other application 142 that is configured to communicate with the application server 130 to configure access control data. In one embodiment, the electronic device 114 communicates with the application server via the network 110. In another embodiment, the electronic device 114 includes the application server 130. In another embodiment, the electronic device communicates configuration information with the application server 130 which is provided by one of the televisions 104.

FIG. 2 illustrates an example of some components that can be included in media access device, for example, a television 104, according to some embodiments. The television 104 includes a display 202 and an audio component 208 in a housing 224. In other embodiments of a media access device 104, but one or both of the display 202 and audio component 208 can be disposed outside of the housing 224. The display 202 can comprise CRT, plasma, LCD, LED, or OLED technology, or another other suitable display technology for presenting visual multimedia content. The audio component 208 can include an output system to provide an audio output signal and/or one or more speakers.

The television 104 illustrated in FIG. 2 also includes a receiver 204 and a network transceiver 206. The receiver 204 refers to a device that can be configured to receive control information from remote control device 106, for example, receive a signal corresponding to one of the one or more button actuation sequences to identify a user profile for login. The receiver 204 can also refer to a device that receives multimedia data. Network transceiver 206 receives multimedia content from a multimedia content provider and can communicate (e.g., send and receive) information with other components of the system 100 (FIG. 1), for example, the application server 130, electronic device 114, and residential gateway 112.

The television 104 shown in FIG. 2 also includes a processor 220 configured with a user profile control manager 134, and a memory component 212 configured with a user profile control database 136, which can operate similarly to the user profile control manager 134 and user profile control database 136 described in FIG. 1. The processor 220 may communicate with the display 202 and the memory 212, the receiver 204, and an input device such as the remote control device 106 or a front panel control. The processor may also communicate with other access devices 104, the application server 106, or electronic devices 114 via the network transceiver 710. The processor 220 may be configured to perform the various functions associated with the television 104. The user profile control database 136 can be any type of data structure that stores information, including a database for example a relational database, lookup tables, linked lists, or other type of data storage structure. The memory component 212 can be any type of electronic memory including RAM memory, flash memory, ROM memory, EPROM memory, EEPROM memory, registers, hard disk, a removable disk, a CD-ROM, or any other form of storage medium known in the art. The memory component 212 is coupled to the processor such the processor can read information from, and write information to, the memory component 212. In some embodiments, the memory component 212 may be integral to the processor 220, or embodied as two memory components, one disposed integral with the processor 220 and the other disposed separate from the processor 220.

In one embodiment, memory component 212 includes an instruction storage medium, having instructions (or data indicative of such instructions where the instructions are stored in compressed or encrypted form) that causes the processor 220 to perform functions associated with the television 104. In addition, or instead of the remote control device 106, the television 104 may implement any other suitable input mechanism including those discussed above with reference to identifying a viewer. The network transceiver 206 may comprise any suitable network interface such as wired or wireless Ethernet and be configured to communicate with the application server 130 via the network 110.

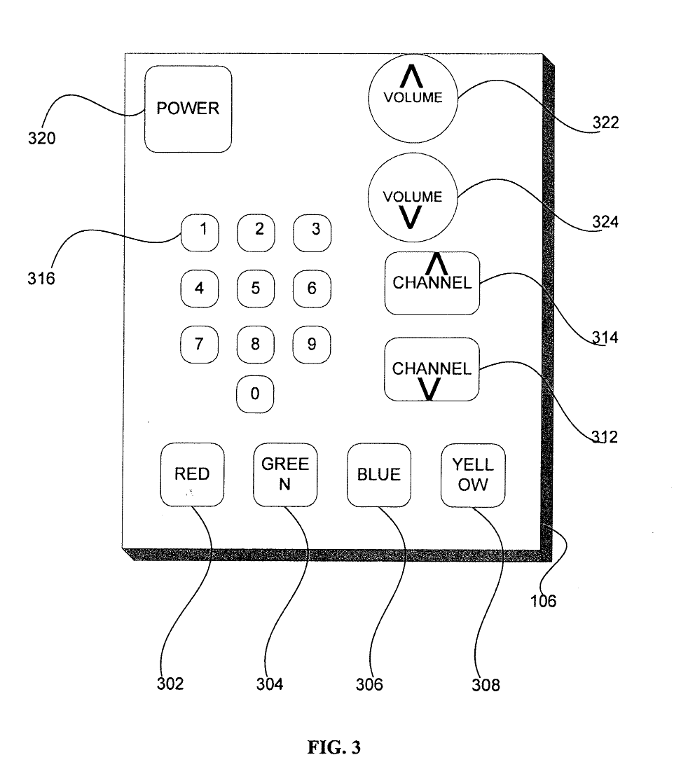

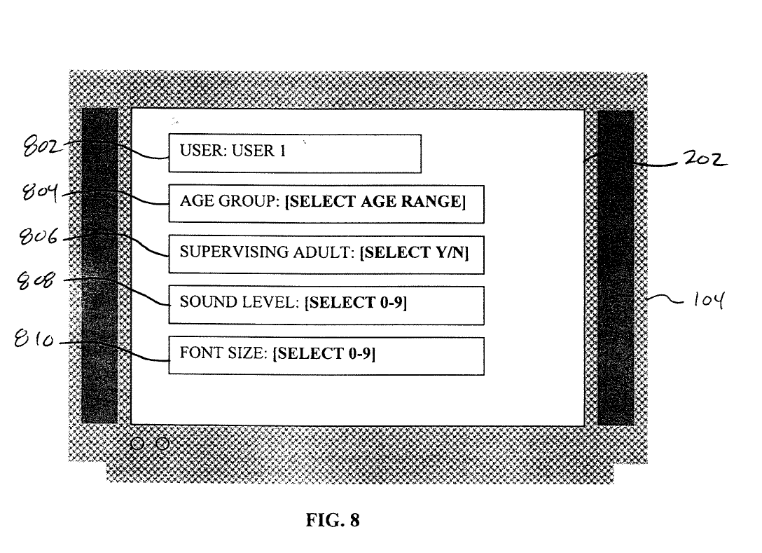

FIG. 3 is a front view of one embodiment of a remote control 106 that is configured to provide control signals to the media access device 104. The remote control 106 can include numerous control buttons, for example, power on/off 320, channel selection 312, 314, and volume controls 322, 324. The remote control 106 may also be configured with one or more buttons to identify a user. In some embodiments, the remote control 106 is configured to generate and communicate a login signal upon the actuation of one color button (for example, red button 302, green button 304, blue button 306, and/or yellow button 308), thus providing a fast and simple one-color/one-button identifier for user login. In some embodiments, the remote control 106 can be configured to generate and communicate a login signal upon actuating multiple color buttons in a predetermined sequence (for example, blue button 306 followed by red button 302), or one of the color buttons more than once (for example, green button 304 twice). Numeric buttons 316 or other buttons (for example alphanumeric buttons (not shown)) may be used to enter a viewer password/identifier. In various embodiments, any of these buttons can be used to input or select user profile characteristics/attributes presented to a user on an interface, such as the interface of a media access device 104 illustrated in FIG. 8.

Still, referring to FIG. 3, in one embodiment each color button 302, 304, 306, 308 of the control device 106 can be associated with a user profile such that actuation of a single color button quickly and easily logs in the associated user to the media access device 104. The association between a color button, or an actuation sequence of color buttons, and a user/user profile can be predetermined. For example, a television 104 product can initially associate red button 302 with user 1, green button 304 with user 2, blue button 306 with user 3, and yellow button 308 with user 4. In some embodiments, the association between the color button(s) and the user profile is stored in the user profile control database 136, in either the media access device 104 or the application server 130 (FIG. 1), or both. Once a user is logged in, the user can logout by again actuating the same one or more button sequence used to login.

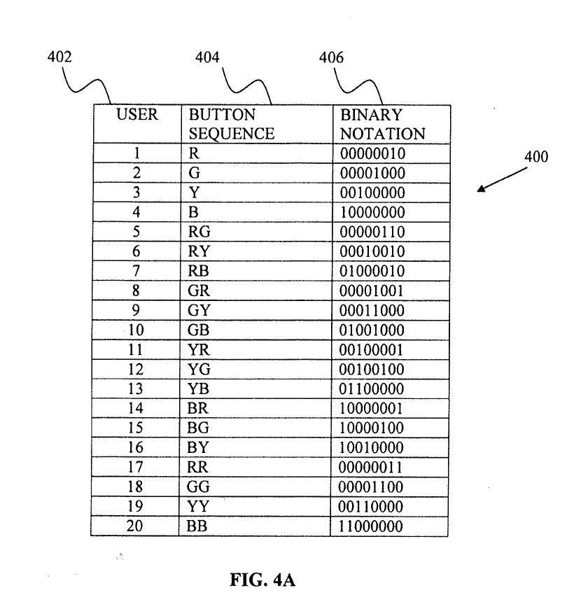

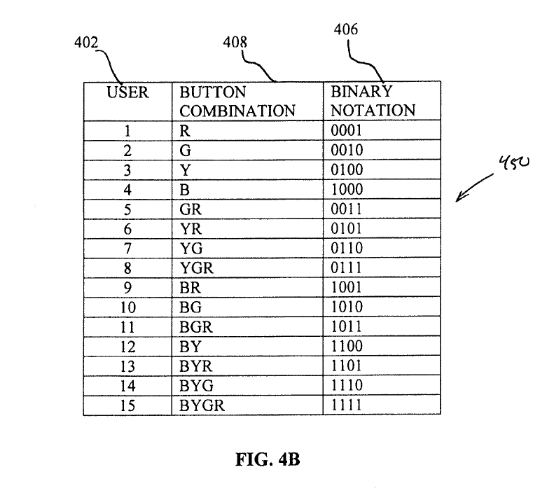

FIGS. 4A and 4B show two tables 400, 450 (respectively) illustrating examples of button sequences (FIG. 4A) and button combinations (FIG. 4B) relating to one or more of four color buttons (e.g., on a remote control) that can be used to login user profiles (or users), according to some embodiments. Referring first to FIG. 4A, table 400 includes a user column 402 listing twenty (20) users. Table 400 also illustrates examples of single button and two-button ordered sequences 404 of a red (“R”), green (“G”), yellow (“Y”), and blue (“B”) button. In other words, the buttons are actuated in a particular order. Each button sequence is associated with one of the twenty users 402. A binary notation 406 can be associated with each button sequence and user. The binary notation and can be communicated in a signal from the remote control device 106 to the television 104 to indicate which particular user is logging in. For example, actuating single button “R” corresponds with user 1 and binary notation “0000010.” The same two buttons can be used, in a different sequence, to indicate two different users. For example, button sequence “RG” corresponds with user 5 and binary notation “00000110,” where button sequence “BG” corresponds with user 15 and binary notation “100000100.” In some embodiments, button sequences can include actuating a single button more than one time. For example, button sequence “RR” corresponds with user 17 and binary notation “00000011.” The practical implementation of using the same button more than one time in a button actuation sequence (e.g., “RR”) can take into account the time between button actuations to distinguish a user login of “RR” from a user logging in by actuating “R” and then quickly logging off by again actuating “R.” In this example the binary notation is 8 bits, however, a suitable binary notation can be greater or less than 8 bits, and sized to accommodate a desired number of users. For example, a 4 bit binary notation can be used to support up to sixteen users. In some embodiments, another suitable type of data structure other than the described binary notation can be communicated to indicate a particular user login.

Table 450 in FIG. 4B illustrates various button actuation combinations that can be used to login a plurality of users, according to one embodiment. In table 450, column 402 lists users 1-15. Column 404 lists examples of single buttons, and combinations of the red, green, yellow, and blue buttons that can be actuated and used to login fifteen users that are associated with the listed sequences. In some embodiments, the buttons are actuated in combination simultaneously. In other embodiments, the buttons are actuated in combination but not simultaneously, but also not in a predetermined order, for example, such user 5 could be logged in by actuating buttons,“GR” or “RG.” In this embodiment, the login button combinations comprise one to four buttons. Column 406 lists examples of binary notations associated with each button combination that can be communicated in a signal from the remote control device 106 to the television 104 to indicate which particular user is logging in. In this embodiment, actuating single button “R” corresponds with the binary notation “0001” and user 1. Button combination “YGR” corresponds with user 8 and binary notation “0111.” Button combination “BYGR” corresponds with binary notation “1111” and user 15. In this way, the four color buttons can be used to indicate logins for up to fifteen different users. One of skill in the art will appreciate that an implementation using button combinations for login may be easier, but the user may have difficulty using some combinations depending on the button layout and design.

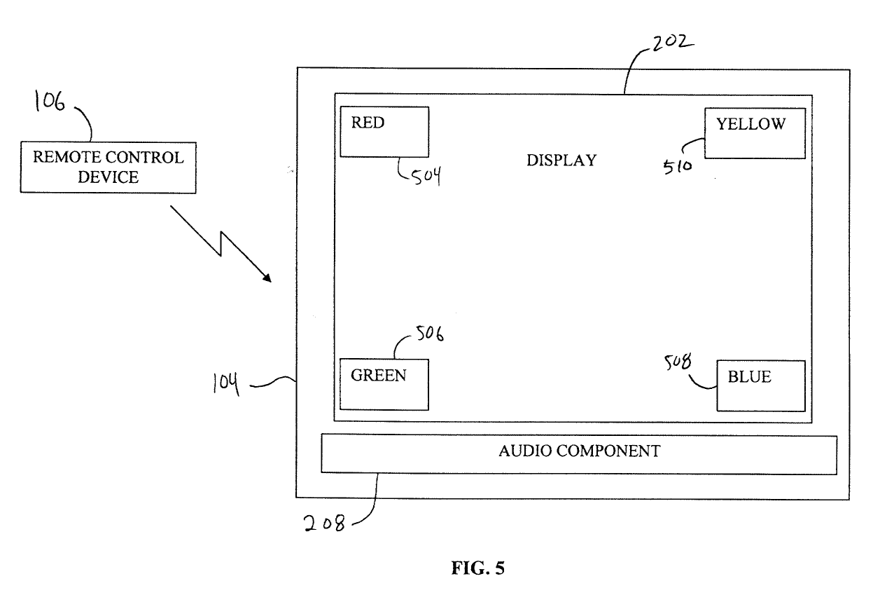

FIG. 5 illustrates an embodiment of an interface to login to a media access device 104 (e.g., as shown in FIGS. 1 and 2). In this embodiment, one or more virtual color buttons red 504, green 506, blue 508, and yellow 510 are presented on a display 202 of the media access device 104. The remote control device 106 is configured to select one or more of the virtual buttons by moving an indicator to the desired virtual color button. Button selection is then communicated to the media access device 104, and a user profile control manager 134 determines an active user profile to use to control multimedia content provided to an output system (e.g., the display 202 and/or audio component 208) of the media access device 106.

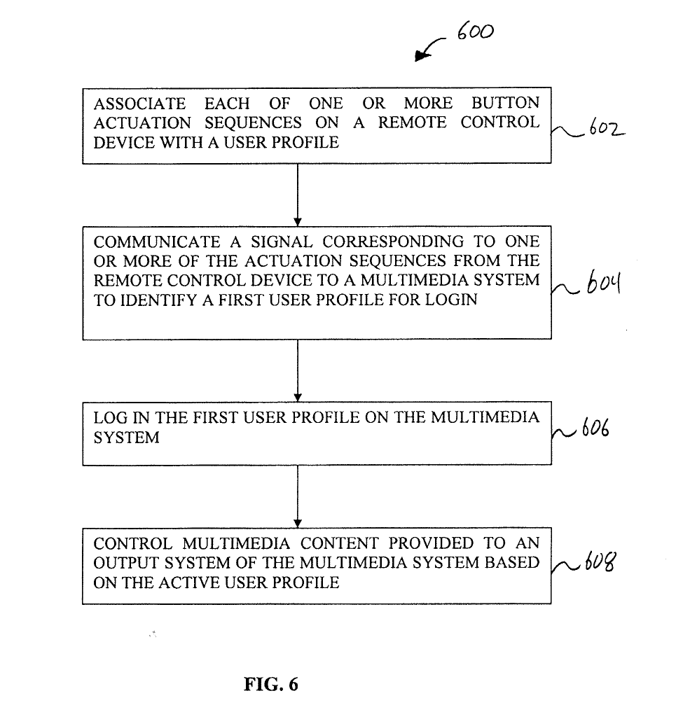

FIG. 6 is a flowchart illustrating one embodiment of a method 600 of controlling multimedia content output to a multimedia system, e.g., a television or other media access device 104, based on a user login. The method begins at a block 602 in which an association is formed between a login actuation sequence and a user profile. In some embodiments this includes associating an actuation sequence of one or more buttons on a remote control device 106 with a viewer. In some embodiments, the associations can be stored in a user profile control database 136 accessed by a user profile control manager 134 on a media access device 104 or an application server 130. The actuation sequence can include actuating a single button, actuating multiple buttons, or actuating a button multiple times. In some embodiments, the buttons are color buttons on the remote control device 106.

Next at block 604, a signal corresponding to an actuation sequence is communicated from a remote control device 106 to the multimedia system to identify a first user profile for login. In other words, the television 104 identifies a viewer of the content based on the login signal it receives. In one embodiment, the television 104 includes a remote control with color labels that are assigned to each viewer of the television 104. In embodiments in which the user identifies themselves with a button or a series of buttons, the button or series of buttons may include numeric buttons, pictorial buttons, or buttons associated with any set of remote commands. In response to identifying the viewer, the television 104 may optionally display an icon (e.g., in the color associated with the viewer, or an icon or graphic associated with the viewer) to confirm the selection of the viewer.

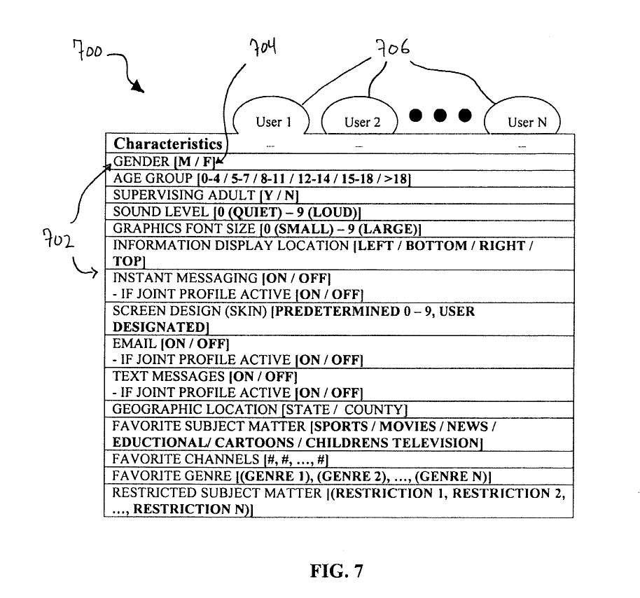

Moving to block 606, the method 600 logs in the first user profile on the multimedia system. In one embodiment, this can be performed by a user profile control manager 134 on a media access device 104 or an application server 130 (FIG. 1). The user profile control manager 134 uses the first user login as the active profile. If two or more users log in, the user profile control manager 134 determines an active profile based on the user profiles of the two or more logged in users. Moving to block 608, the method 600 then controls multimedia content provided to an output system of the multimedia system based on the active user profile. The one or more characteristics of the active user profile are used to control the multimedia content presented to the logged in user. The output system can be one or both of a display 202 and an audio output component 208. Specifically, the multimedia content output is controlled by characteristics of the active user profile, which are further described below in connection with FIG. 7.

FIG. 7 is a schematic illustrating an example representation of a data structure 700 that can be used to store user profiles 1, 2, . . . , N 706 according to one embodiment. Data structure 700 can be any suitable information storage structure including but not limited to a database (e.g., a relational database), a lookup table, or linked data lists. A user profile includes one or more characteristics 702 (for example but not limited to, gender, age group, supervising adult, sound level, graphics font size, information display location, instant messaging, screen design, email, text messages, geographic location, favorite subject matter, favorite channels, favorite genre, and restricted subject matter, which are discussed further below). FIG. 7 also illustrates attributes 704 (the attributes being illustrated in [brackets]) that are related to each of the characteristics 702. Each characteristic has at least one attribute 704. For example, as illustrated in FIG. 7, the attributes for the characteristic gender is “M” or “F.” In some embodiments the user profiles all have the same characteristics. In some embodiments of such cases, the characteristics may initially reflect a default value that can be personalized to a particular user. In other embodiments, a user profile can have one or more of a variety of characteristics, selectable by an authorized user (e.g., an adult owner of the multimedia system), such that the characteristics can be added or deleted from a user profile. In addition, a user profile can be personalized to the associated user by changing one or more attributes of its characteristics. In some embodiments the attributes are selectable from a list. In some embodiments, the attributes may be entered by a user.

In some embodiments, the characteristics of a user profile can include one or more of gender, age group, whether user is a supervising adult, sound level (e.g., initial sound level, or sound level limits), graphics font size, display information location, and screen design. Other characteristics of a user profile can include one or more of whether to enable communications with the logged in user for email, text messages, and instant messages, and whether such communications should be enabled if a joint user profile is the active profile, indicating that two or more users are logged and may be viewing any displayed communications. Other characteristics of a user profile can include one or more of geographic location, favorite subject matter; favorite channels, favorite genre, and restricted subject matter. In some embodiments, the characteristics can be used to independently control multimedia content provided to an output system. In some embodiments, selecting a particular attribute of one characteristic affects the attribute of another characteristic such that some attributes can be automatically selected. For example, if the age group attribute “0-4” is selected, the supervising adult attribute “N” can be automatically selected, e.g., by the user profile control manager 134. In some embodiments, a user can override the automatic attribute selection. While data structure 700 illustrates certain characteristics and attributes according to one embodiment, user profiles can be employed that have additional characteristics and/or attributes, or that do not have some of the listed characteristics and/or attributes.

FIG. 8 is a example of a portion of a user interface that can be displayed on a display of a television 104 and used for tailoring characteristics of a user profile for a particular user, according to one embodiment. In FIG. 8, five characteristic fields are displayed on the television 104. However, the user interface can be scrolled down to access other characteristic fields. Here, the user interface includes a user identification field 802 that identifies the user profile being tailored (or generated). In this embodiment, the user interface includes an age group field 804 which has a selectable age group range attribute. The user interface includes a supervising adult field 806 with a selectable “Y/N” attribute. The user interface of FIG. 8 also illustrates a sound level field 808 with a selectable sound level range “0-9,” and a font size field with a selectable size range “0-9.” In one embodiment the television 104 independently provides the user interface. In one embodiment, the television 104 is in communication with the application server 130 which provides the user interface. Alternatively, or in addition, the application server 130 may provide the user interface via an e-mail, SMS, or web interface to the television 104 or other electronic devices 114. In one embodiment, a user must be authenticated before gaining access to the interface for tailoring user profiles, for example, by providing a password to the media access device 104. In one embodiment, data entered for each user profile can be stored in the user profile control database 136, residing on either, or both, of an application server 130 or the media access device 104. As noted above the application server 130 may synchronize the updated data with one or more media access devices 104, or provide ant received updated data when requested by the media access devices 104. In one embodiment, a plurality of media access devices share and/or synchronize user profile information over a wireless or wired network, for example, a LAN, WAN, a Bluetooth network, or the Internet.

FIG. 9 depicts an example of a state diagram illustrating a multi-user login for some embodiments of a multimedia system, for example, the multimedia system 100 illustrated in FIG. 1, or an individual media access device television 104 (FIG. 2). A user profile control component, (e.g., the user profile control manager 134 (FIGS. 1 and 2), can be configured to implement the joint user profile functionality described below in reference to FIG. 9. In the example illustrated in FIG. 9 there are three users, designated as users A, B, and C. P(X) is a user profile. Each arrow in the state diagram represents a login operation. The reverse direction of each arrow represents a logout operation.

When a media access device is powered on at state 902, a default user profile P(none) is applied to control multimedia content initially presented. P(none) is a default profile and has no personalized characteristics. When user A logs in, at state 904 user A's login profile P(A) is applied as the active user profile. Similarly, when user B or user C logs in when no other user has logged in, the default profile P(none) is replace by P(B) at state 906 or P(C) at state 908, respectively, and these profiles are applied as the active user profiles for each respective case. When user B logs in while user A is still logged, P(A) is replaced by a joint profile for A and B, P(AB) at state 910, as the active user profile. The same profile P(AB) may be applied when user A logs in while user B is already logged in. When user C logs in while user A is logged in, P(A) is replaced by a joint user profile for users A and C, P(AC) at state 912, as the active user profile. The same profile, P(AC) at state 912, may be applied when user A logs in while user C is already logged in. When user C logs in while user B is logged in, P(B) is replaced by a joint user profile for users B and C, P(BC) at state 914, as the active user profile. The same profile, P(BC) at state 914, may be applied when user B logs in while user C is already logged in. When user A, B, and C are logged in at the same time, a joint user profile P(ABC) at state 916, replaces any of the previous user profiles as the active user profile. Thus, this login method allows the second (or third or fourth . . . ) user to login without forcing the first user to logout. When multiple users are logged in, joint or group user profiles are applied instead of applying one of the profiles of the logged in users.

In some embodiments, the user profile control manager 134 (FIGS. 1 and 2) can be configured with algorithms that create a joint user profile based on the union or intersection of the information in each individual user profile, or based a predetermined priority, or both. In some embodiments, multimedia systems include capabilities to “data-mine” the viewed content, that is, gather information by monitoring the multimedia content viewed by one or more users (as indicated by the user profile applied while the content is being viewed). One of skill in the art will appreciate the systems and processes available for data-mining. In some embodiments, the information gathered from data-mining can be used to update or change preferences or settings in a user profile or joint user profile.

In operation, the resulting joint user profile shown in each state is applied as the active user profile. Multimedia content provided to an output system of the multimedia system is controlled based at least in part on the active user profile (for example, on characteristics of the active user profile). A user profile control manager 134 (e.g., as illustrated FIGS. 1 and 2) can process login information, determine a joint user profile if required, and determine an active user profile. By defining multi-user profiles, multimedia content viewing can be personalize not only for each individual user, but also groups of users. This can be advantageous for content provides and sponsors when data mining or viewership reporting is enabled because it more precisely reflects the viewers and their attributes (e.g., age group, gender, geographic location). This information can be used to create more accurate recommendation for users for future television selection.

As illustrated in FIG. 9, for the case of three users there are six joint user profiles needed. As the number of users grows, the number of joint profiles grows exponentially. In other words, 2ⁿ−n−1 joint user profiles are needed for n users. A joint user profile can be generated based on one or more characteristics and associated attributes of each logged in user profile, and then applied as the active user profile to control multimedia content provided to an output system. The logged in user profiles may combined in many ways. However, creating some joint user profiles can be simplified with little loss of perceived benefit. In some embodiments, a user needs permission to provide inputs to the generation of a joint profile. For example, a user may be required to enter a password to personalize an individual user profile or a joint user profile. Examples of several joint profiles are described below. Of course, these are only a few of the joint profiles that can be formed using one or more user characteristics, for example, the user characteristics illustrated in FIG. 7. One of skill in the art will appreciate that many other joint profiles can be formed based on one or more characteristics of the logged in users individual profiles.

### EXAMPLE 1

### Family Profile

In one example, user A is a father, user B is a mother, users C, D and E are children of user A and user B. In addition to creating their individual profiles P(A), P(B), P(C), P(D), and P(E), a joint profile “husband-and-wife” P(AB) can be created. In some embodiments, combinations of logged in users A, B, and C, or A, B, and D, or A,B, and D can be shared by a family (joint) profile, thereby reducing the number of user profiles required. In this family profile at least one of the parents (A and/or B) is logged in and thus can provide supervision for multimedia content viewed by any of the kids (C, D, and/or E). In some embodiments, a family profile can be created that includes either, or both, user A or user B, and one or more of their kids C, D, and E, the idea being that the family profile is appropriate whenever there is at least one parent user A or user B logged in, and when at least one of their kids user C, D, or E is also logged in. Determining a family profile as a joint profile reduces the number of user profiles for users A, B, C, D, and E by twenty-one. Some of the characteristics in a user profile are still personal (for example, instant message identify) when joint profiles are used. In such cases, joint profiles may keep the information for each individual characteristic, if necessary.

### EXAMPLE 2

### Male/Female Adult Profile

In another example, two adults a male and a female, living in the same household may have a joint user profile when both are logged into a multimedia system. In this example, the joint profile characteristics are not necessarily used to block certain multimedia content but rather determine preferences that are acceptable for both users. For example, the individual male and female user profiles may have characteristics relating to sound level, favorite channels, favorite genre, favorite subject matter, and whether to display text messages that may affect generating the joint user profile.

### EXAMPLE 3

### Guest/Household Adult Profile

In another example, a joint profile can be applied when a “guest” is logged in and when one or more household adults are logged in. In this case, a “guest joint user profile” may be applied that allows unrestricted access to most information available from the multimedia system, but keeps certain information private to the household adult. For example, in this joint profile communications sent to the household adult (for example, text messages and/or emails) are not displayed. The household adult may set up the guest joint user profile such that it does not include, for example, favorite channels, favorite genre, or one or more other preferred characteristics of the household adult. In this way, a guest may enjoy experiencing multimedia content at the home (or other location) of the household adult while maintaining privacy of the household adult homeowner. In other embodiments, a similar type of joint privacy profile can be implemented for multimedia content in a business or work environment.

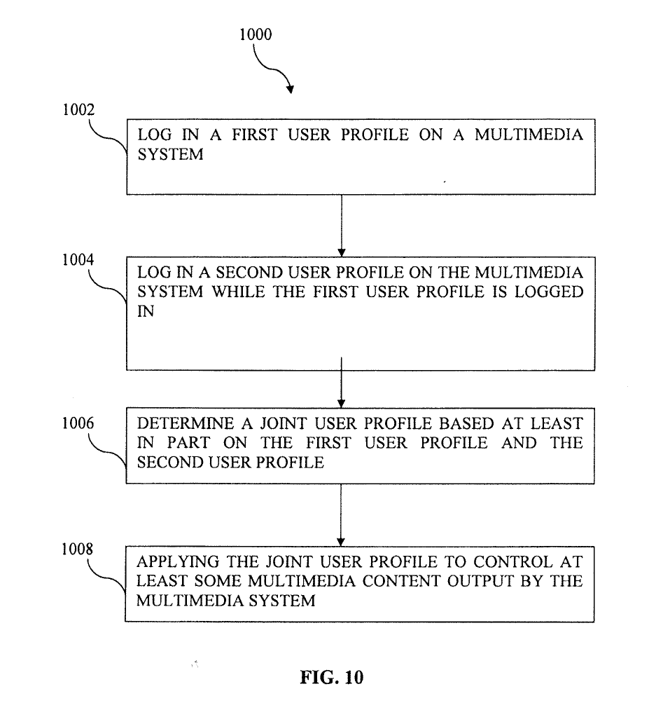

FIG. 10 is a flowchart illustrating one embodiment of a method 1000 of determining a joint user profile to control multimedia content. At block 1002, the method 1000 comprises logging in a first user on a multimedia system. The first user can be logged in using various means to provide a signal to the multimedia system, including a remote control device 106 (FIG. 2) or a user interface located on the multimedia system. In one embodiment, a user profile control manager residing on a media access device 104 (e.g., see FIG. 2) or an application server 134 (e.g., see FIG. 1) application server in communication with the media access device, logs in the first user profiles based on receiving a first login signal.

At block 1004, the method comprises logging in a second user profile on the multimedia system while the first user is logged in. In one embodiment, a user profile control manager, residing on a media access device 104 (e.g., see FIG. 2) or an application server 134 (e.g., see FIG. 1) in communication with the media access device, logs in the second user profile based on a receiving a second login signal. At block 1006, the method comprises determining a joint user profile based at least in part on the first user profile and the second user profile. In some embodiments, the user profile control manager determines the joint user profile. At block 1008, the method 1000 comprises applying the joint user profile to control at least some multimedia content output by the multimedia system. In some embodiments, additional users profiles can be logged in. A joint user profile may be determined every time an additional user logs in. A joint user profile may also be determined when a user profile is logged out and two or more user profiles remain logged in.

It is to be recognized that depending on the embodiment, certain acts or events of any of the methods described herein can be performed in a different sequence, may be added, merged, or left out all together (e.g., not all described acts or events are necessary for the practice of the method). Moreover, in certain embodiments, acts or events may be performed concurrently, e.g., through multi-threaded processing, interrupt processing, or multiple processors, rather than sequentially.

Those of skill will recognize that the various illustrative logical blocks, modules, circuits, and algorithm steps described in connection with the embodiments disclosed herein may be implemented as electronic hardware, computer software executed by on or more processors, or combinations of both. To clearly illustrate this interchangeability of hardware and software, various illustrative components, blocks, modules, circuits, and steps have been described above generally in terms of their functionality. Whether such functionality is implemented as hardware or software executed by a processor depends upon the particular application and design constraints imposed on the overall system. Skilled artisans may implement the described functionality in varying ways for each particular application, but such implementation decisions should not be interpreted as causing a departure from the scope of the present invention. For example, the various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a television or other access device. In the alternative, the processor and the storage medium may reside as discrete components in a television or other access device.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A method of determining a joint user profile to control multimedia content presented by a multimedia system for personalizing a multimedia experience for two or more users, the method comprising:
logging in a first user profile on the multimedia system;
logging in a second user profile on the multimedia system while the first user profile is logged in;
determining a joint user profile based at least in part on the first user profile and the second user profile; and
applying the joint user profile to control at least some multimedia content output by the multimedia system.

2. The method of claim 1, wherein the multimedia system comprises a television, and the method further comprises presenting multimedia content on the television.

3. The method of claim 1, further comprising:
associating one or more characteristics affecting presentation of multimedia content with the first user profile; and
associating one or more characteristics affecting presentation of multimedia content with the second user profile,
wherein the joint user profile comprises characteristics determined at least in part by at least one characteristic associated with the first user profile or the second user profile.

4. The method of claim 3, wherein the one or more characteristics relate to one or more of favorite channels, favorite genre, personal bookmarks, rating limits, instant messenger identities, picture configurations, sound configurations, preset search keywords, screen design, and viewing history.

5. The method of claim 3, wherein characteristics associated with the joint user profile include a set of characteristics defined by the intersection of characteristics associated with the first user profile and characteristics associated with the second user profile.

6. The method of claim 4, wherein characteristics associated with the joint user profile include a set of characteristics defined by the union of one or more characteristics associated with the first user profile and one or more characteristics associated with the second user profile.

7. The method of claim 1, further comprising:
associating a first signal with the first user profile;
associating a second signal with the second user profile; and
receiving the first and second signal in the multimedia system,
wherein the multimedia system logs in the first user profile based on receiving the first signal, and
wherein the multimedia system logs in the second user profile based on receiving the second signal.

8. The method of claim 7, further comprising communicating the first signal and the second signal from a remote control device to the multimedia system.

9. The method of claim 1, further comprising:
logging in at least one additional user profile; and
re-determining a joint user profile to apply to control at least some of the multimedia content presented by the multimedia system, the joint user profile based at least in part on the first user profile, the second user profile, and the at least one additional user profile.

10. The method of claim 9, further comprising re-determining the joint user profile if a user profile is logged off and two or more user profiles remain logged in.

11. The method of claim 10, further comprising applying a single logged in user profile to control at least some multimedia content output by the multimedia system if only one user profile is logged in.

12. The method of claim 1, further comprising:
gathering content viewing information by monitoring multimedia content output by the multimedia system while the joint user profile is applied; and
changing the joint user profile based on the monitored content.

13. The method of claim 12, wherein content viewing information comprises data relating to one of more of: which show was viewed, how long was a show viewed, when was a show viewed, and which channels were viewed.

14. A method of controlling multimedia content output by a multimedia system, the method comprising:
logging in two or more user profiles to a multimedia system;
applying a joint user profile to control at least some multimedia content output by the multimedia system, the joint user profile based at least in part on the two or more logged in user profiles.

15. The method of claim 14, further comprising determining the joint user profile.

16. The method of claim 14, further comprising:
logging in a third user profile such that there are at least three logged in user profiles; and
applying a joint user profile to control at least some multimedia content output by the multimedia system, the joint user profile based at least in part on the at least three logged in user profiles.

17. The method of claim 16, further comprising:
logging off one of the logged in user profiles; and
re-determining a joint user profile to control at least some multimedia content output by the multimedia system, the re-determined joint user profile based at least in part on the two or more remaining logged in user profiles.

18. A multimedia system, comprising:
a processor configured to
log in two of more user profiles to a multimedia system;
determine a joint user profile based at least in part on the two or more logged in user profiles; and
apply the joint user profile to control multimedia content output by the multimedia system.

19. A multimedia system, comprising a processor configured to determine a joint user profile for controlling multimedia content presented on a display based at least in part on two or more logged in user profiles.

20. The multimedia system of claim 19, further comprising a television, the television comprising the display.

21. The multimedia system of claim 19, further comprising:
an output system,
wherein the processor is further configured to apply the joint user profile to control multimedia content output by the output system.

22. The multimedia system of claim 21, wherein the output system comprises a display for outputting visual multimedia content.

23. The multimedia system of claim 21, further comprising a receiver in communication with the processor, the receiver configured to receive signals corresponding to user profiles for logging in to the multimedia system,
wherein the processor is further configured to log in user profiles based on the signals received by the receiver.

24. The multimedia system of claim 23, further comprising an input device configured to generate signals corresponding to user profiles and communicate the signals to the receiver.

25. The multimedia system of claim 24, wherein the input device comprises a remote control device.

26. The multimedia system of claim 23, further comprising:
a memory component configured to store at least one characteristic associated with each of the two or more logged in user profiles, and
wherein the processor is configured to determine the joint user profile based at least in part on at least one characteristic associated with the first user profile or the second user profile.

27. A computer-program product for determining a joint user profile for personalizing a multimedia experience, the product comprising:
a computer-readable medium having stored thereon codes executable by at least one processor to:
log in two of more user profiles to a multimedia system;
determine a joint user profile based at least in part on the two or more logged in user profiles; and
apply the joint user profile to control at least some of the multimedia content output by the multimedia system.

28. A system for determining a joint user profile for personalizing a multimedia experience, comprising:
means for logging in two of more user profiles to a multimedia system;
means for determining a joint user profile based at least in part on the two or more logged in user profiles; and
means for applying the joint user profile to control at least some of the multimedia content output by the multimedia system.

29. The system of claim 28, wherein the logging in means comprises a remote control device.

30. The system of claim 28, wherein the determining means comprises a processor in communication with the remote control device and configured to receive a signal from the remote control means indicative of a user profile for login.

31. The claim of claim 28, wherein the applying means comprises the processor.
